(19) United States
(12) Patent Application Publication
(10) Pub. No.: US 2015/0049048 A1
(43) Pub. Date: Feb. 19, 2015

(54) ASSEMBLY OF THE PRECISION STYLUS FOR THE CAPACITANCE TOUCH SCREENS

(71) Applicant: KUANG YUAN TSAI, New Taipei City (TW)

(72) Inventor: KUANG YUAN TSAI, New Taipei City (TW)

(21) Appl. No.: 14/334,681

(22) Filed: Jul. 18, 2014

Related U.S. Application Data
(60) Provisional application No. 61/867,234, filed on Aug. 19, 2013.

(51) Int. Cl. G06F 3/0354; G06F 3/044

(52) U.S. Cl. CPC G06F 3/03545; G06F 3/044
USPC 345/174; 345/179

(57) ABSTRACT

A stylus pen comprises a main body, a conductive rubber carrier, a steel capillary tube, a conductive flexible extending member extending downward from the steel capillary tube, a conductive contacting film electrically connected with the conductive flexible extending member, and a supporting member provided on an upward surface of the conductive contacting film. The stylus pen has larger degrees of operating angle, and has sufficient contact area when contacting on a capacitance touch screen without visual block.

### FIELD OF THE INVENTION

The present invention relates to a stylus pen, and more particularly to a stylus pen having larger operating angles in relation to a touch screen for the purpose of convenience as being used on a touch control device.

### BACKGROUND OF THE INVENTION

Nowadays, many touch control devices such as mobile phones, personal digital assistants, and tablet PCs have been widely used in human's life. Usually, the touch control device is equipped with a capacitance touch screen for data input. A stylus pen can be used to interact with the capacitance touch screen by contacting it. When in use, the position where a pen tip of the stylus pen contacts the capacitance touch screen can be determined by capturing the charge variation generated by the stylus pen.

It always needs sufficient contact area between the stylus pen and the capacitance touch screen for properly generating effective charge variation, a type of stylus includes an electrically conductive handle portion and an electrically conductive contact portion has been used for providing the sufficient contact area with a larger operating angle compared to the conventional stylus with a tip of broad flat surface, the interconnection component between the electrically conductive handle portion and the electrically conductive contact portion is with a ball shaped structure or a spring to provide larger operating angle in relation to the capacitance touch screen.

### DESCRIPTION OF THE RELATED ART

Referring to FIG. 1, the cross sectional view of a stylus 100 comprises a interconnection component 101 between the electrically conductive handle portion 102 and the electrically conductive contact portion 103, the interconnection component 101 is with a ball shaped structure 101A works with the supporting member 104 above the electrically conductive contact portion 103 as a ball joint, however, as shown on FIG. 2, the operating angle of the electrically conductive handle portion 102 will be limited by the nonconductive supporting member 104, resulting to a narrow range of operating angle, furthermore, the electrically conductive surface 103A of the electrically conductive contact portion 103 may lose contact with the interconnection component 101 while operating in critical angles and cause a poor performance.

Referring to FIG. 2 and FIG. 3. The interconnection component 101 with a ball shaped structure 101A can be replaced by a spring 201 as the interconnection component between the electrically conductive handle portion 202 and the electrically conductive contact portion 203, the force applied to the electrically conductive handle portion 202 by the user is transmitted to the electrically conductive contact portion 203 through the spring 201, and it always needs a curve length for the spring to bend to the using angle, user has to use the stylus more gently since the force applied to the stylus may also damage the spring 201, resulting in a strange user experience different to the feeling of using a regular pen.

### SUMMARY OF THE INVENTION

The present invention overcomes the drawbacks of the prior arts, and provides a stylus pen, comprising: a main body; a conductive rubber carrier which is inserted into the main body; a steel capillary tube which is inserted into the conductive rubber carrier; a flexible extending member made of a conductive flexible material, extending downward from the steel capillary tube; a conductive contacting film, being electrically connected with the extending member, having a downward surface for contacting a touch control device and an upward surface; and a supporting member, provided on the upward surface of the conductive contacting film.

In an embodiment of the present invention, the conductive flexible material is conductive rubber or conductive sewing string.

In an embodiment of the present invention, the main body is used as a capacitor and is electrically connected with the extending member.

In an embodiment of the present invention, the supporting member has a through hole thereon for being inserted by the extending member.

In an embodiment of the present invention, the stylus pen further comprises an adhesive layer provided between the supporting member and the conductive contacting film.

In an embodiment of the present invention, the supporting member has a disc portion for supporting the conductive contacting film.

In an embodiment of the present invention, both of the supporting member and the conductive contacting film are transparent.

Thereby, the extending member is used as a joint having greater degrees of freedom between the main body and the conductive contacting film, the steel capillary tube provides the rigidity property to the extending member so the force applied by the user to the main body can be fully and immediately transmitted to the conductive contacting film and the supporting member, that the stylus pen of the present invention can have larger operating angle in relation to the touch screen and a regular using feeling, as a traditional pen. Further, the conductive rubber carrier is placed between the main body and the steel capillary tube makes the steel capillary tube being easily and tightly inserted into the main body, components of the stylus except the main body, are easily remove and replaceable. Moreover, in the case that the conductive contacting film and the supporting member are transparent, it allows user to clearly see what is drawn on the touch screen.

### BRIEF DESCRIPTION OF THE DRAWINGS

The structure and the technical means adopted by the present invention to achieve the above can be best understood by referring to the following description of the preferred embodiments and the accompanying drawings

FIG. 1 is a cross sectional view of a stylus with a ball joint applied to it, the stylus is with a narrow range of the operating angle shown by dotted arrows.

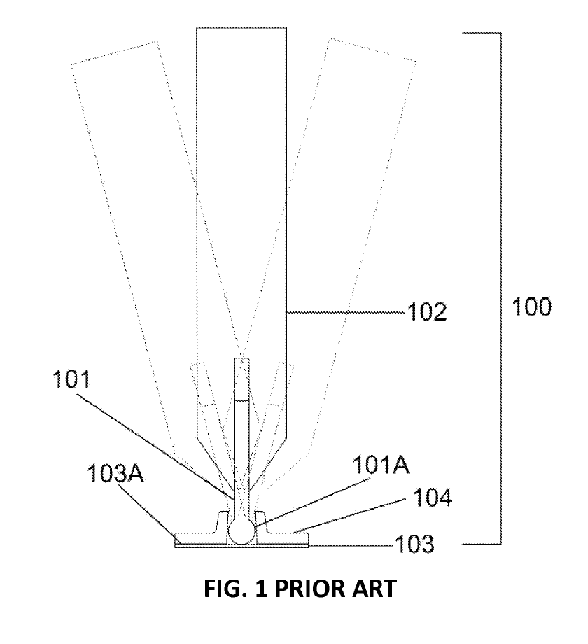

FIG. 2 is a cross sectional view of a stylus with a ball joint applied to it, shows the operating angle is limited by the supporting member and the electrically contact losing from the interconnection component to the electrically conductive contact portion while operating in a critical angle.

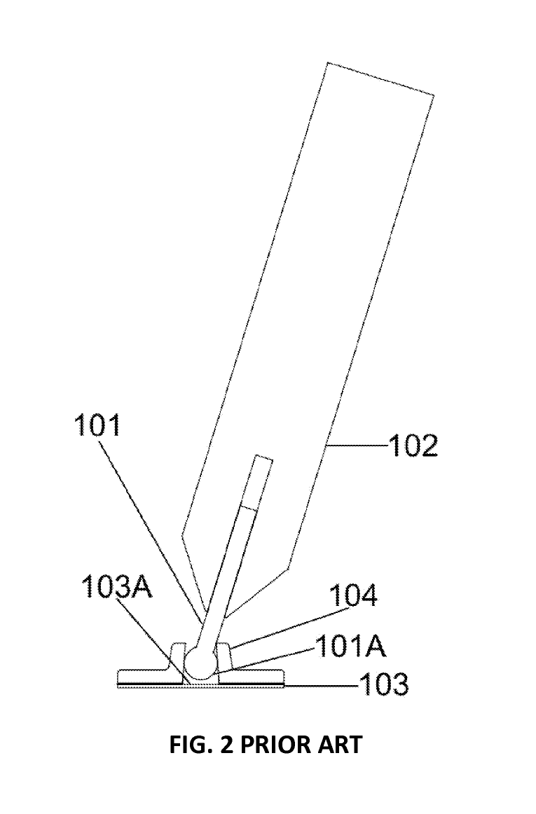

FIG. 3 is a side view of the stylus with a spring as the interconnection component between the electrically handle portion and the electrically conductive contact portion.

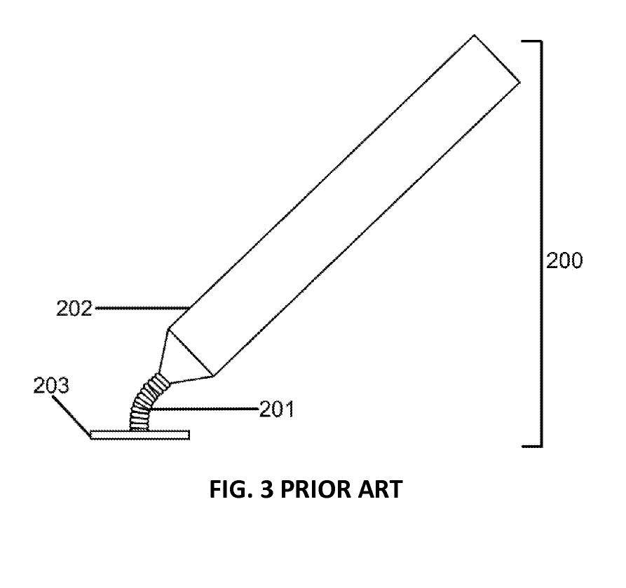

FIG. 4 is a perspective view of a stylus pen according to an embodiment of the present invention.

FIG. 5 is an explosive view of the pen tip portion of the stylus pen of the FIG. 4.

FIG. 6 is a cross sectional view of the pen tip portion of the stylus pen of FIG. 4.

FIG. 7 is a cross sectional view of the pen tip portion of the stylus pen of FIG. 4 when being used in a different operating angle;

### DETAILED DESCRIPTION OF THE PREFERRED EMBODIMENTS

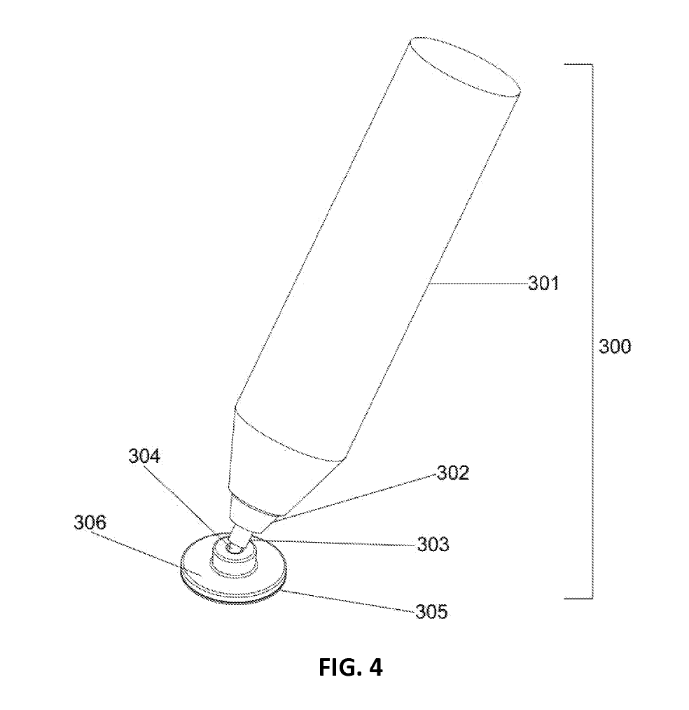

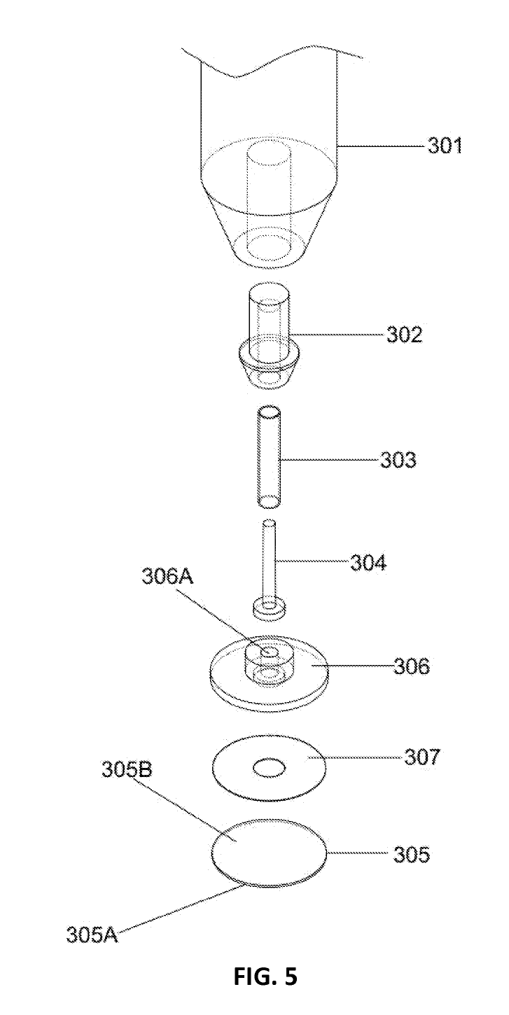

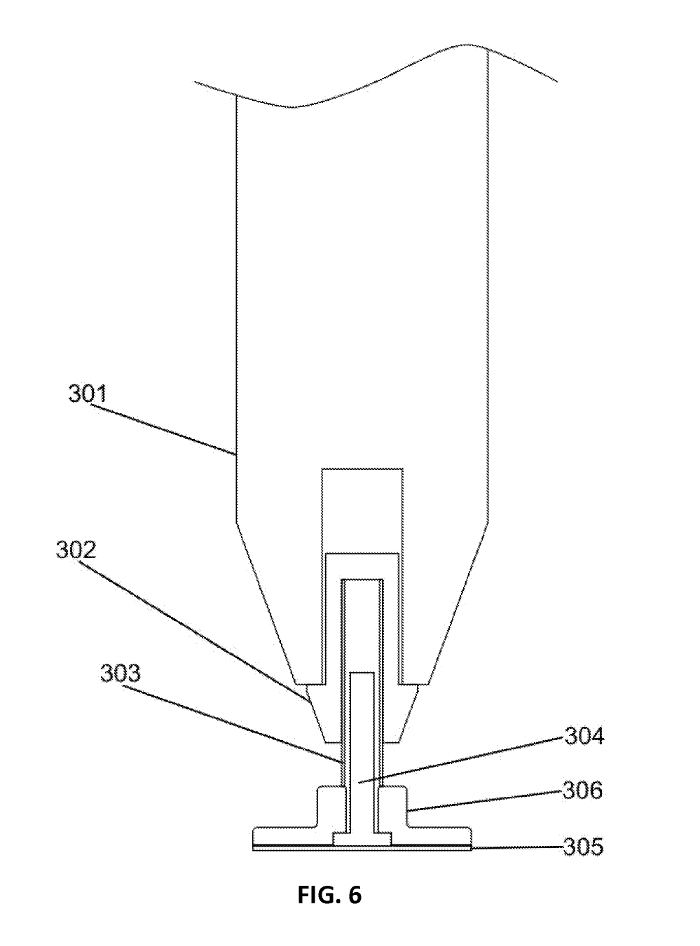

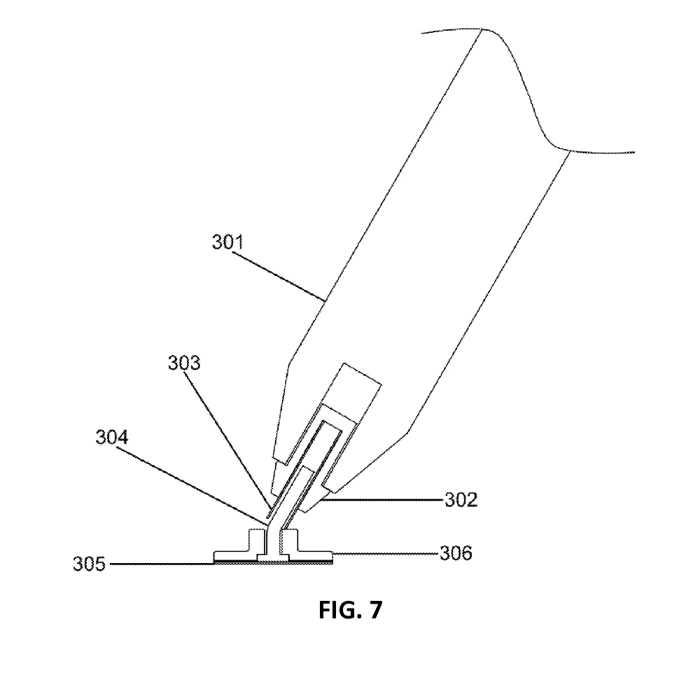

Please refer to FIGS. 4-7. A stylus pen 300 according to an embodiment of the present invention mainly includes a main body 301, a conductive rubber carrier 302, a steel capillary tube 303, an extending member 304, a conductive contacting film 305 and a supporting member 306.

By the elastic and soft property of the conductive rubber carrier 302, the pen tip portion of the stylus can be easily remove and replaced.

The main body 301, such as a penholder, can be hold or attached by a user. The conductive rubber carrier 302 is inserted into the main body 301. The steel capillary tube 303 is inserted into the conductive rubber carrier 302. The extending member 304 is provided extending downward from the steel capillary tube 303. The conductive contacting film 305, electrically connected with the extending member 304, has a downward surface 305A for contacting a touch control device (not shown) and has an upward surface 305B. And, the supporting member 306 is provided on the upward surface 305B of the conductive contacting film 305.

In some embodiments, the main body 301 may be used as a capacitor, entirely or in part, to provide a larger capacitance. In that case, the main body 301 is electrically connected with the extending member 304 via the conductive rubber carrier 302 and the steel capillary tube 303. Thereby, the conductive contacting film 305 is electrically connected to the capacitor (main body 301) via the extending member 304, steel capillary tube 303 and conductive rubber carrier 302, such that the charge variation generated by the stylus pen 300 can be increased. Moreover, the main body 301 may be in electrical connection with human body (through human fingers), by being provided with a conductive portion thereon for contacting with the human body, to get a larger capacitance for the charge variation.

In the present invention, the extending member 304 is made of a electrically conductive and flexible material, such as conductive rubber, conductive sewing string, or the like. With the flexible property of the extending member 304, the stylus pen 300 can have larger operating angles in relation to the touch screen for the purpose of convenience as being used on a capacitance touch screen (not shown). The extending member 304 can be bent in any direction in such a manner to make the downward surface 305A of the conductive contacting film 305 to get a sufficient contact area to the capacitance touch screen.

The conductive contacting film 305 is a film made of a electrically conductive material. Preferably, both of the conductive contacting film 305 and the supporting member 306 are transparent, so that view of the drawing line will not be blocked when using the stylus pen 300 on the capacitance touch screen.

The supporting member 306 is used for supporting the conductive contacting film 305. According to this embodiment, the supporting member 306 is provided on the upward surface 305B opposite to the downward surface 305A for supporting the conductive contacting film 305. By the supporting member 306, a push force from the user can be applied effectively to the conductive contacting film 305 to make the downward surface 305A of the conductive contacting film 305 closely contact the capacitance touch screen.

In addition, the supporting member 306 may have a through hole 306A thereon, that the supporting member 306 can be assembled with the extending member 304 by inserting the extending member 304 into the through hole 306A.

In order to prevent the conductive contacting film 305 from coming off the supporting member 306, an transparent adhesive layer 307 is provided between the conductive contacting film 305 and the supporting member 306. Of course, it is preferred that there is no adhesive layer between the conductive contacting film 305 and the extending member 304, otherwise the electrical connection there between may be lost.

With above structure, the extending member 304 is used as a joint having greater degrees of freedom between the main body 301 and the conductive contacting film 305, that the stylus pen 300 can have larger operating angle in relation to the touch screen, as a traditional pen. Further, the steel capillary tube 303 protects the extending member 304 and helps on transmitting the force applied by the user from the main body 301 to the supporting member 306 and the conductive contacting film 305, providing a similar using experience compared to a regular pen. Moreover, the transparent conductive contacting film 305, transparent adhesive layer 307 and the transparent supporting member 306 allow user to clearly see what is drawn on the capacitance touch screen even if the downward surface 305A of the conductive contacting film 305 has a large area for the charge variation.

What is claimed is:

1. A stylus pen, comprising:
a main body;
a conductive rubber carrier;
a steel capillary tube;
an extending member, made of a electrically conductive and flexible material, being electrically connected with the main body, the conductive rubber carrier and the steel capillary tube, extending downward from the steel capillary tube;
a conductive contacting film, being electrically connected with the extending member, having a downward surface for contacting a touch control device and an upward surface; and
a supporting member provided on the upward surface of the conductive contacting film.

2. The stylus pen as claimed in claim 1, wherein the electrically conductive and flexible material is conductive rubber or conductive sewing string.

3. The stylus pen as claimed in claim 1, wherein the main body is used as a capacitor and is electrically connected with the extending member.

4. The stylus pen as claimed in claim 1, wherein the supporting member has a through hole thereon for being inserted by the extending member.

8. The stylus pen as claimed in claim 1, further comprising a transparent adhesive layer provided between the supporting member and the conductive contacting film.

9. The stylus pen as claimed in claim 1, wherein the supporting member has a disc portion for supporting the conductive contacting film.

10. The stylus pen as claimed in claim 1, wherein both of the supporting member and the conductive contacting film are transparent.
